(19) United States
(12) Patent Application Publication
(10) Pub. No.: US 2014/0096371 A1
(43) Pub. Date: Apr. 10, 2014

(54) Automated Assembly Apparatus for Making a Motor Component and Method of Making

(71) Applicants: Dale K. Wells, Dayton, OH (US); Dane A. Belden, Montgomery, OH (US)

(72) Inventors: Dale K. Wells, Dayton, OH (US); Dane A. Belden, Montgomery, OH (US)

(21) Appl. No.: 13/646,975

(22) Filed: Oct. 8, 2012

(51) Int. Cl. H02K 15/02

(52) U.S. Cl. 29/596; 29/732; 29/705

(57) ABSTRACT

A system for making a stator includes a stator laminate forming area for receiving at least one stator plate to form part of a stator laminate, an automated plate lift for lifting and positioning at least one the stator plate in a predetermined position in the stator laminate forming area and a mechanism for enabling movement of the stator plates between the stator laminate forming area and the plate lift.

### BACKGROUND OF THE INVENTION

1. Field of the Invention

This invention relates to a method and apparatus for making a motor component. More particularly, the invention relates to an apparatus and method for stacking a plurality of individual stator plates in a manner to form a stator laminate from a plurality of individual stator plates.

2. Description of the Prior Art

There are a number of techniques for forming motors and generators which require the assembly of a plurality of plates into groups or stacks to form a laminate. Currently, the laminate is formed at least in part by hand positioning the individual plates in a cylindrical pattern to form a stator laminate. This can result in many injuries to the worker in the way of repetitive motion damage or cuts.

The previously known method of assembling a plurality of plates into a stack having a precise height was to manually select an appropriate number of plates and to measure and adjust the total height of the stack such that it would be exactly a predetermined height and position. In practice it was found that the laminates were manufactured such that there were variances in manufacturing as well as labor risk. Manual methods of producing a stack of laminate plates is slow, costly and occasionally inaccurate.

There have been attempts at making automated stacking machines. Such prior machines did not produce a suitable stack without the need of some manual intervention during the stacking process. One prior device released and dropped plates from the bottom of a dispensing magazine onto an intermittently operated endless belt conveyor but the plates were manually positioned to form a core. Such assembling apparatus could produce a pile of laminates having a precise number of laminates, however, they were not capable of providing a laminate of suitable formation.

Accordingly, there remains a need for an improved machine which can form a motor component, such as a stator, with minimal manual intervention. The present invention overcomes the aforementioned disadvantages and difficulties of the prior art apparatus and methods.

### SUMMARY OF THE INVENTION

It is an object to improve the method of making motor component.

It is a further object to provide an apparatus for making motor component.

Still a further object is to provide an apparatus in accordance with the present invention which is quiet, reliable, relatively inexpensive to manufacture and to operate, efficient and accurate, and capable of operating at relatively high speeds.

More particularly, the present invention provides a method and apparatus for making a motor component wherein a stack plates form a laminate having a predetermined height from a plurality of individual plates. The present invention eliminates the need for manually stacking and manually positioning a stack of plates to a form a predetermined configured stator laminate.

Accordingly, the invention is directed to an apparatus for assembling a stack of a plurality of individual plates wherein the stack has a predetermined height and the individual plates have a predetermined thicknesses. The apparatus for making a stator includes a stator laminate forming area for receiving at least one stator plate to form part of a laminate of the stator, an automated stator plate lift for lifting and positioning the stator plate in a predetermined position in the stator laminate forming area, and mechanism for enabling movement of the automated stator lift relative to the laminate forming area.

The apparatus includes a chassis having a movably connected magazine for containing the stator plates, a magazine drive mechanism operably connected to the magazine for moving the magazine, a movably connected stator plate lift for lifting one of the plates from the magazine, and a plate lift drive mechanism operably connected to the plate lift for actuating the plate lift and positioning the plate lift. The plate lift drive mechanism can include a vertical lift drive operably connected to the plate lift for advancing the lift vertically to pick up the plate and a horizontal lift drive for advancing the plate lift horizontally to dispose the plate lift in the stator laminate forming area.

The apparatus includes a guide for positioning the apparatus in the stator laminate forming area, particularly against the stator laminate. A computer based device is operably connected to the drive mechanisms. A first sensor, which can include a laser sensor, can be operably connected to the computer based device and operably disposed to measure stator laminate height as it is formed. A second sensor, which can include a laser sensor, can be operably connected to the computer based device and operably disposed to measure stator plate height particularly the top plate on the magazine. In this way, depending on the stator laminate to be formed, the magazine height is advanced and accounts for relative height of the plate stack of the stator laminate being formed.

The lift can include a pair of suction and release cups, for example, which are laterally spaced from one another and include a movable depressor operably disposed therebetween. The apparatus further includes a tamping mechanism operably associated with the same in a manner to tamp a plate delivered on the stack stator laminate into proper position.

The stator laminate forming area includes a stator laminate support movably controlled by the computer based device. It is further contemplated that the invention include a transporting mechanism which serially transports a stack of plates to the magazine. The computer based device controls a number of plates added for producing a stack having a predetermined height.

The method according to the present invention includes the following steps:

providing a stator plate laminate forming area including at least one stator plate to form part of a laminate of the stator, and providing an automated stator plate lift for lifting and positioning a stator plate in a predetermined position in the stator laminate forming area in a manner to form a stator laminate.

The method further includes employing a mechanism for enabling movement of the automated stator plate lift relative to the stator laminate forming area. The method includes measuring the height of the stator laminate as it is formed and employing a computer based device for controlling the automated lift as a function of the height measured. The step of positioning the stator plate includes placing one end of the plate down first and employing a depressor on an inward section of the plate to bend and push out air as a second end is released and let down in the stator laminate forming area.

Other features, objects, and advantages of the present invention will be discussed in or are apparent from the detailed description of the presently preferred embodiment of the invention located herein below.

### BRIEF DESCRIPTION OF THE DRAWINGS

FIG. 1 is a side view according to the invention.

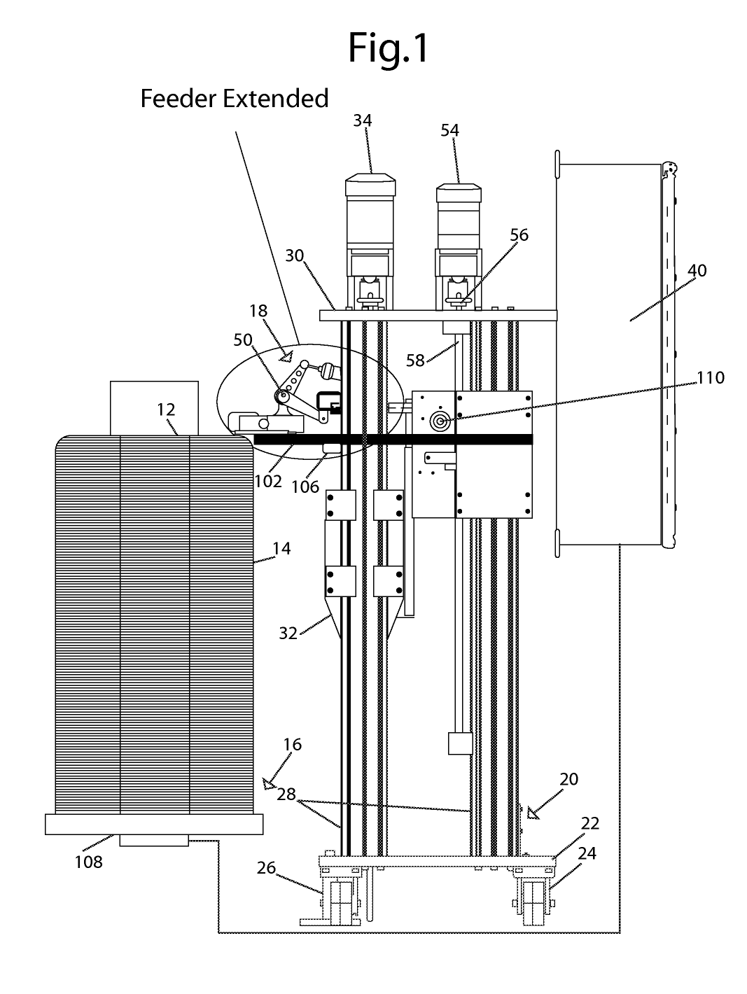

FIG. 2 is a side view of the invention.

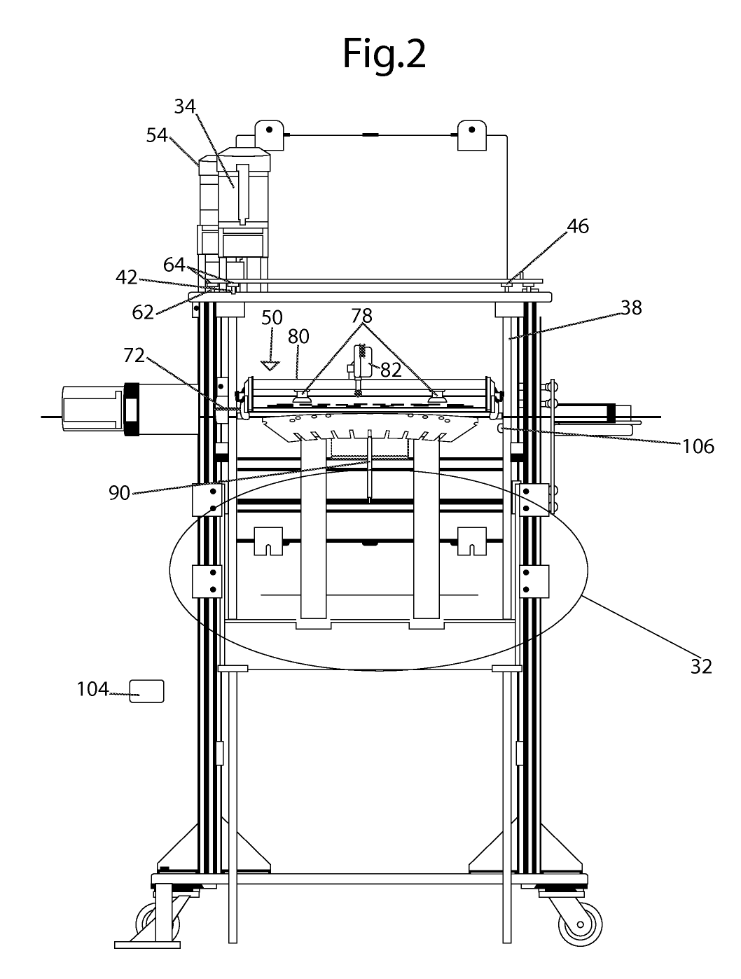

FIG. 3 is a top view of the invention.

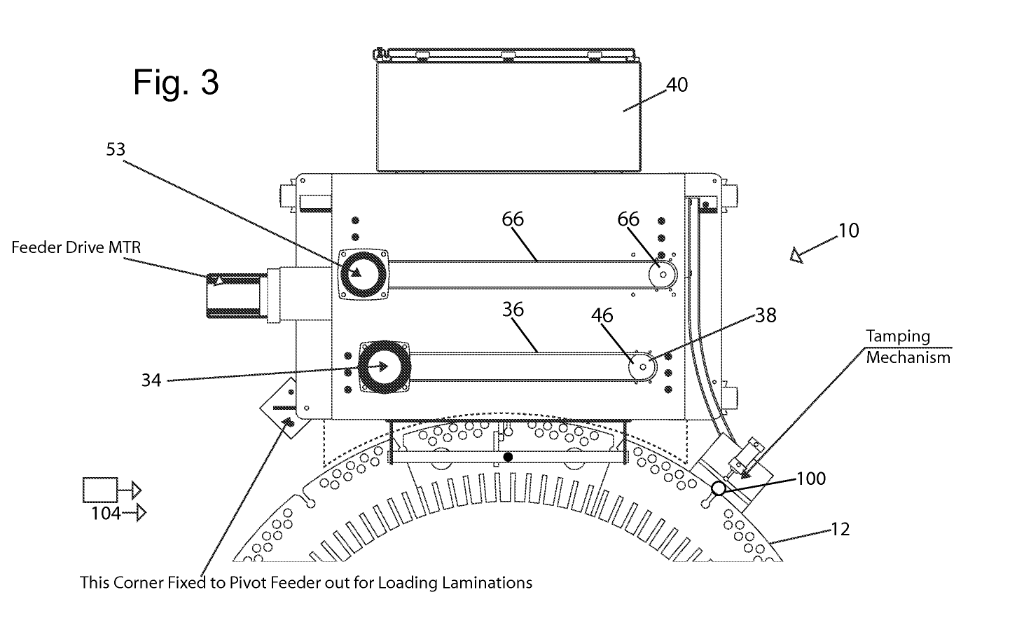

FIG. 4 is a perspective of the invention.

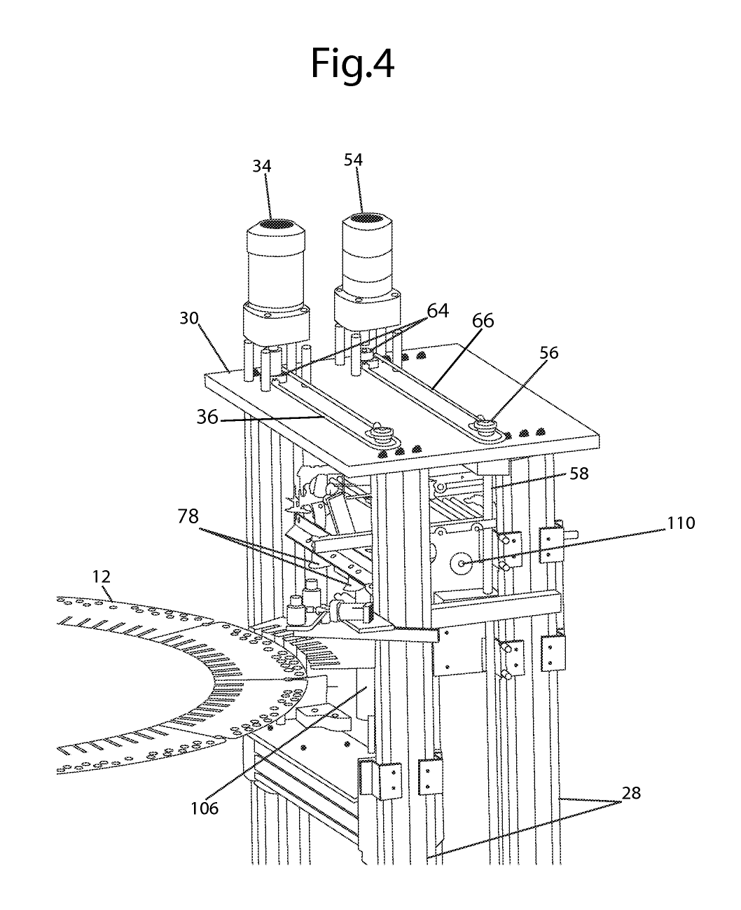

### DETAILED DESCRIPTION OF THE PREFERRED EMBODIMENT

Referring now to the drawings, an apparatus of the instant invention is generally designated by the numeral 10. The apparatus 10 is particularly well suited for making a stator by assembling a stack of a plurality of individual stator plate, 12 wherein the stack has a predetermined height and the individual plates 12 have a predetermined thicknesses to form a stator laminate 14.

The apparatus 10 includes stator laminate forming area 16 for receiving one or more stator plates 12, an automated stator plate lift 18 for lifting and positioning stator plate 12 in a predetermined position to form part of stator laminate 14 in the stator laminate forming area 16, and mechanism described hereinafter for enabling relative movement between the plate lift 50 and the stator laminate forming area 16.

The apparatus 10 includes a chassis 20 having a base support plate 22 with a plurality of rotatably mounted wheels 24, at least one or more of which having a locking mechanism 26 for locating position of the chassis 20 as desired. In this way, the chassis 20 can be easily moved or pivoted as required. The chassis 20 includes a plurality of vertical rails 28 which interconnect the base support plate 22 to a top support plate 30.

A magazine 32 for containing the stator plates 12 is slidably movably connected to a pair of the vertical rails 28 which are forwardly disposed. A magazine drive mechanism includes a drive motor 34, drive chain 36 and drive screw 38 which are operably interconnected to the magazine 32 and a computer based device 40 and power supply (not shown) for moving the magazine 32 vertically in a predetermined manner. The drive motor 34 is mounted such that a motor drive shaft 42 having a drive sprocket 44 operably connects to the drive chain 36 which in turn connects to a drive sprocket 46 fixed to drive screw 38. Drive screws 38 are threadably received through threaded side bores (not shown) in magazine 32 such that when the drive screws 38 turn in one direction or the other, the magazine 32 raises or lowers respectively.

The automated stator plate lift 18 for lifting one of the stator plates 12 from the magazine 32 includes a pneumatic lifting arm 50 which is connected to lift carriage 52 which slidably movably connected to a pair of the vertical rails 28 which are rearwardly disposed. A lift carriage drive mechanism includes a drive motor 54, drive chain 56 and drive screw 58 which are operably interconnected to the lift carriage 52 and computer based device 40 and power supply (not shown) for moving the lift carriage 22 vertically in a predetermined manner, The drive motor 54 is mounted such that a motor drive shaft 62 having a drive sprocket 64 operably connects to the drive chain 66 which in turn connects to a drive sprocket 66 fixed to drive screw 38. Drive screws 38 are threadably received through threaded side bores (not shown) in lift carriage 52 such that when the drive screws 38 turn in one direction or the other, the lift carriage 52 raises or lowers respectively. Additionally, there is provided a drive motor 70 which is connected to lift carriage 52 and has a drive shaft 72 which connects to a sprocket or gear 74 which operably interconnects to a sprocket or gear surface 76 (not seen) of the pneumatic lift arm 50 in a manner to cause the pneumatic lift arm 50 to move laterally (i.e., horizontally) back and forth. In this way, there is provided both horizontal and vertical movement of the pneumatic lift arm 50. The pneumatic lift arm 50 can include a pair of suction and release cups 78, for example, which are laterally spaced from one another and operably mounted on a cross bar 80 connected to the lift arm 50. Operably disposed between the cups 78 is a vertically movable depressor 82 operably connected to the computer based device 40. In this regard, components of the pneumatic lift arm 50 are operably connected to the computer based device 40.

A magnetic separator 90 is operably disposed adjacent the magazine 32 and operably connected to the computer based device 40. The magnetic separator 90 works with cups 78 and depressor 82 to ease the process in removing the stator plate 12 from the magazine 32 and to the stator laminate forming area 16. The invention provides for ease in separation of the stator plates 12 from one stack on the magazine 32 and places them on a stack forming the stator laminate 14 in a manner which avoids skating between the stator plates which would normally occur as a result of air being trapped between the stator plates 12. This is achieved through synchronized control with the computer based device 40 operating the various components as follows:

With the magnetic separator 82 activated, the cups 78 are actuated downward to operably engage a top stator plate 12 on the magazine 32 and then actuated upward to lift the stator plate 12 therefrom. The lift arm 50 is actuated to then moves horizontally forward to a predetermined position over the stator laminate forming area 16. One of the cups 78 releases the stator plate 12 causing an end thereof to drop on a lower disposed stator plate 12 of the laminate 14. As part of the apparatus 10, there is a provided a tamping mechanism, wherein a depressor 82 is then actuated to cause to depress a mid section of the stator plate 12 to squeeze air out between the to be mated stator plates 12. Once so depressed and while holding the stator plates 12 in position, the remaining cup 78 releases and the stator plate 12 which is now on top is substantially positioned.

Further, a pneumatic roller 100 is operably associated with the chassis 20, e.g., connected thereto, and operably connects to the computer based device 40 to in a manner to retractably engage the “just dropped” stator plate 12 as it passes thereby and assure seating the same into proper position.

The apparatus 10 can also include a guide plate 102 for positioning the chassis 20 adjacent the stator laminate forming area 16, particularly against the stator laminate 14 as it is formed. A powered rotatable mandrel 108 is operably connected to the computer based device 40 and is controlled to rotate a predetermined amount as described by the operation herein,

A first sensor 104, which can include a laser sensor, can be operably connected to the computer based device 40 and operably disposed to measure height of the stator laminate 14 as it is formed. A second sensor 106, which can include a laser sensor, can be operably connected to the computer based device 40 and operably disposed to measure height of stator plate 12 on the magazine 32 and such height sensed is transmitted to the computer based device 40. In this way, depending on the stator laminate 14 to be formed, the height of magazine 32 is advanced at a rate which accounts for relative stack height of stator laminate 14 being formed. The stator laminate forming area 16 include the mandrel 108 movably which is controlled by the computer based device 40. The computer based device 40 is operably connected to all the drive mechanisms previously mentioned to synchronize feed rate.

It is further contemplated that the invention include a transporting mechanism which serially transports a stack of plates to the magazine 32. In this regard this can include a conveyor belt. It is contemplated that the computer based device 40 can control such conveyor for delivering the number of plates to provide a stack of plates 12 having a predetermined height on the magazine 32.

The present invention has been described above but is not intended to be limited by the described embodiment. Rather, the modifications, derivatives and improvements should be afforded to the claims which are appended hereto.

What is claimed is:

1. A system for making a stator, which includes:
a stator laminate forming area for receiving at least one stator plate to form part of a stator laminate; and
an automated plate lift for lifting and positioning at least one said stator plate in a predetermined position in said stator laminate forming area.

2. The system of claim 1, which includes a magazine having a plurality of plates in stacked relation from which said automated plate lift lifts said at least one stator plate.

3. The system of claim 2, which includes a magazine drive operably connected to said magazine.

4. The system of claim 2, which includes a lift drive operably connected to said automated plate lift.

5. The system of claim 2, which includes a chassis having said magazine which includes a magazine drive which is operably connected to said magazine for actuating said magazine.

6. The system of claim 1, which includes a tamping mechanism for performing a tamping operation on said stator plates of said stator laminate.

7. The system of claim 6, which includes a chassis having said tamping mechanism operably connected thereto.

8. The system of claim 1, which includes an electronic stator laminate height measuring device.

9. The system of claim 1, which includes a magazine having a plurality of plates forming a stack from which said automated plate lift lifts said at least one stator plate and an electronic stator plate height measuring device for measuring height of said stacked plates.

10. The system of claim 9, which includes a magnetic separator operably associated with said stack.

11. The system of claim 1, which includes a chassis operably connected to said a magazine having a plurality of plates forming a stack from which said automated plate lift lifts said at least one stator plate and a magnetic separator operably associated with said stack.

12. The system of claim 11, which further includes an electronic stator plate height measuring device for measuring height of said stacked plates.

13. The system of claim 9, which includes an electronic stator laminate height measuring device.

14. The system of claim 1, which includes a guide plate operably connected to said automated plate lift wherein said guide for positioning adjacent said stator laminate.

15. The system of claim 1, which includes a computer based device operably connected to said automated plate lift.

16. The system of claim 1, wherein said automated plate lift includes at least on suction release cup and an automated depressor.

17. The system of claim 8, wherein said height measuring device includes a laser and a computer based device.

18. The system of claim 9, wherein said height measuring device includes a laser and a computer based device.

19. The system of claim 13, wherein said height measuring device includes a laser and a computer based device.

20. The system of claim 1, a mechanism for enabling movement of said stator plates between said stator laminate forming area and said plate lift.

21. A method of forming a stator, which comprises the steps of:
(a) providing a stator plate laminate forming area including at least one stator plate to form part of a laminate of the stator; and
(b) providing an automated stator plate lift for lifting and positioning a stator plate in a predetermined position in the stator laminate forming area in a manner to form a stator.

22. The method of claim 21, which includes employing a mechanism for enabling movement of the automated stator plate lift relative to the stator laminate forming area.

23. The method of claim 21, which includes measuring height of the stator laminate as it is formed and employing a computer based device for controlling the automated lift as a function of the height measured.

24. The method of claim 21, wherein said step of positioning the stator plate includes placing one end of the plate down and employing a depressor on an inner section of the plate to bend and push out air as a second end is released and let down in the stator laminate forming area.
